(19) United States
(12) Patent Application Publication
(10) Pub. No.: US 2026/0109560 A1
(43) Pub. Date: Apr. 23, 2026

(54) DOCK HOUSE WITH SPLIT DECK LEVELER FOR DRIVE THROUGH LOADING DOCK

(71) Applicant: Leum Engineering, Inc. d/b/a Dockzilla Co., Minnetonka, MN (US)

(72) Inventors: Grant Gilbert Leum, Excelsior, MN (US); Eric Moore Demerath, Shepherd, MI (US)

(21) Appl. No.: 19/218,012

(22) Filed: May 23, 2025

Related U.S. Application Data
(60) Provisional application No. 63/710,401, filed on Oct. 22, 2024.

(51) Int. Cl. B65G 69/28

(52) U.S. Cl. CPC B65G 69/2817

(57) ABSTRACT

Various examples are directed to apparatus and methods for a dock house with a split deck leveler for a drive through loading dock. A loading dock includes a split deck ramp including a platform portion configured to be actuated to an approximately horizontal position for safety of a user standing on the platform portion. A base includes top and bottom surfaces, the top surface including an opening to receive the split deck ramp into the opening. A dock housing includes a frame mounted onto the base and configured to be secured to a wall of a building. The dock housing and split deck ramp are configured to provide a lower elevation floor compared to an elevation of a floor of the building, to create a pocket for opening rear vehicle doors and allowing for vertical movement of the back end of the vehicle and the doors.

### CLAIM OF PRIORITY AND INCORPORATION BY REFERENCE

The present application claims the benefit under 35 U.S.C. § 119(e) of U.S. Provisional Patent Application 63/710,401, filed Oct. 22, 2024, the disclosure of which is hereby incorporated by reference herein in its entirety.

### TECHNICAL FIELD

The present disclosure pertains to methods and apparatus for loading dock equipment, and more particularly to methods and apparatus for a dock house with a split deck leveler for a drive through loading dock.

### BACKGROUND

Drive through loading docks allow trailer doors to be opened from inside the building by warehouse workers to eliminate the need for the truck driver to open the doors outside, where the driver could be hit and injured by another trailer, and where the driver or other unauthorized person may potentially take products from inside the trailer. Some food companies desire the ability to open trailer doors from inside the building to maintain the temperature inside the trailer, preserving the cooled temperature inside of the refrigerated trailer to the cooled inside temperature of the building.

Currently the solution is to install a vertical style dock leveler. However, vertical dock levelers have inherent design and safety issues, based first on the fact that they store completely vertical and require the operator to walk in front of their 1,000-2,500 lb. steel weldment to open the trailer doors into the building. This is a major safety concern which requires strict maintenance and operation to keep people from being crushed if the vertical leveler falls or is inadvertently lowered onto the person opening the trailer doors.

A second problem using vertical dock levelers for a drive through dock is that the building and specifically the dock area needs to be modified to create a 12 to 15 inch “step” or pit in the building floor to allow the trailer doors, and specifically the door hooks on the bottom of the doors, to have clearance to be opened into the building. At a standard dock, the building floor is taller than the doors and hooks, thus not allowing the doors to swing into the building. In addition, once an empty trailer is loaded, the suspension on the trailer will squat/lower, thus also requiring a space for the doors to move without contact with the floor. Also, the building opening dock door often is too small to allow the trailer doors the room to swing into the building envelope. To allow room into the building, a 10′ wide×12′ high exterior door is needed and most existing dock doors are 8′-9′ wide×8′-10′ high. The construction to an existing building to create these “pits” in the floor and change the exterior door opening is extremely costly and takes a long time to execute and sometimes is impossible due to the building structure or a leased facility, causing business operational shut down and making stopping the trailer and bumpering difficult.

Thus, there is a need in the art for an improved drive through loading docks.

### SUMMARY

Systems, methods and apparatus for a dock house with a split deck leveler for a drive through loading dock are provided. Various examples are directed to a loading dock including a split deck for a drive through loading dock. The loading dock includes a split deck ramp, a base and a dock housing. The split deck ramp includes a platform portion configured to be actuated to an approximately horizontal position for safety of a user standing on the platform portion. The base includes top and bottom surfaces, the top surface including an opening to receive the split deck ramp into the opening. The dock housing includes a frame mounted onto the base and configured to be secured to a wall of a building. The dock housing and the split deck ramp are configured to provide a lower elevation floor compared to an elevation of a floor of the building, to create a pocket for opening rear vehicle doors and allowing for vertical movement of the back end of the vehicle and the doors during a loading or unloading process.

Various examples are directed to a method of making a loading dock. The method includes providing a split deck ramp including a lower end and an upper end, the upper end abutting a preexisting structure and the lower end including a lower edge, the split deck ramp including a platform portion adjacent the lower edge configured to be actuated to an approximately horizontal position for safety of a user standing on the platform portion. The method also includes providing a base including top and bottom surfaces, the top surface including an opening to receive the split deck ramp into the opening. The method further includes providing a dock housing including a frame mounted onto the base in sections, the sections including a frame-front wall, opposed frame-sidewalls and a frame-top wall, the frame-front wall including a vehicle-receiving opening to receive a back end of a vehicle, the frame-sidewalls configured to be secured to a wall of a building, the dock housing and the split deck ramp configured to provide a lower elevation floor compared to an elevation of a floor of the building, to create a pocket for opening rear vehicle doors and allowing for vertical movement of the back end of the vehicle and the doors during a loading or unloading process.

This Summary is an overview of some of the teachings of the present application and not intended to be an exclusive or exhaustive treatment of the present subject matter. Further details about the present subject matter are found in the detailed description and appended claims. The scope of the present invention is defined by the appended claims and their legal equivalents.

### BRIEF DESCRIPTION OF THE DRAWINGS

1The drawings illustrate generally, by way of example, various embodiments discussed in the present document. The drawings are for illustrative purposes only and may not be to scale.

FIG. 1A is an illustration of a side view of an over the road trailer.

FIG. 1B is an illustration of a rear view of the trailer of FIG. 1A.

FIG. 1C is an illustration of a rear view of the trailer of FIG. 1A, with the rear doors opened.

FIG. 1D is an illustration of a side view of a vertical storing dock leveler.

FIG. 1E is an illustration of a side view of a plurality of vertical storing dock levelers.

FIG. 2A is an illustration of side view of a split deck ramp for a drive through loading dock, according to various embodiments of the present subject matter.

FIG. 2B is an illustration of perspective view of a split deck ramp for a drive through loading dock including a dock housing, according to various embodiments.

FIG. 3 is an illustration of perspective view from outside a building of a loading dock in the stored position, according to various embodiments.

FIG. 4 is an illustration of a section view of the loading dock of FIG. 3.

FIG. 5 is an illustration of perspective view from outside a building of a loading dock in the lowered position, according to various embodiments.

FIG. 6 is an illustration of a section view of the loading dock of FIG. 5.

FIG. 7 is an illustration of a plan view of the loading dock of FIG. 5.

FIG. 8 is an illustration of perspective view from inside a building of a loading dock in the lowered position, according to various embodiments.

FIG. 9 is an illustration of a section view of the loading dock with a ramp in an inclined position and with a lip of the ramp resting on a trailer bed, according to various embodiments.

FIG. 10 is an illustration of a plan view of the loading dock of FIG. 9.

FIG. 11 is an illustration of a section view of the loading dock with a ramp in a declined position and with a lip of the ramp resting on a trailer bed, according to various embodiments.

FIG. 12 is an illustration of perspective view from inside a building of a loading dock in the level position and with a lip of the ramp resting on a trailer bed, according to various embodiments.

FIG. 13 is an illustration of a section view of the loading dock with a ramp in an approximately level position and with a lip of the platform disengaged such that the end of the platform abuts the end of a trailer bed, according to various embodiments.

FIG. 14 is an illustration of a section view of the loading dock of FIG. 13 with the platform in an inclined position and with a lip of the platform disengaged such that the end of the platform abuts the end of a trailer bed, according to various embodiments.

FIG. 15 is an illustration of a section view of the loading dock of FIG. 13 with the ramp in a declined position and with a lip of the platform disengaged such that the end of the platform abuts the end of a trailer bed, according to various embodiments.

FIG. 16 is a block diagram of a machine in the example form of a computer system within which a set of instructions may be executed, for causing the machine to perform any one or more of the methodologies discussed herein.

FIG. 17 is an illustration of hydraulic system components associated with the split deck ramp for a drive-through loading dock, according to various embodiments.

FIG. 18 is an illustration of selected hydraulic system components for the operation of the split deck ramp in a drive-through loading dock, according to various embodiments.

FIG. 19 illustrates a plan view of a loading dock, focusing on the components that provide environmental protection, according to various embodiments.

FIG. 20 illustrates a perspective view from inside a building of a loading dock, highlighting components that contribute to functionality and protection, according to various embodiments.

FIG. 21 illustrates a perspective view from outside a building of a loading dock, highlighting components designed for environmental protection and impact absorption, according to various embodiments.

### DETAILED DESCRIPTION

The following detailed description of the present subject matter refers to subject matter in the accompanying drawings which show, by way of illustration, specific aspects and embodiments in which the present subject matter may be practiced. These embodiments are described in sufficient detail to enable those skilled in the art to practice the present subject matter. References to “an”, “one”, or “various” embodiments in this disclosure are not necessarily to the same embodiment, and such references contemplate more than one embodiment. The scope of the present invention is defined by the appended claims, along with the full scope of legal equivalents to which such claims are entitled.

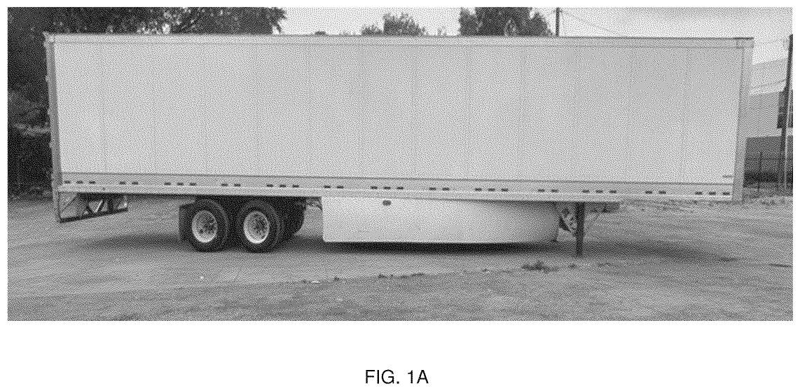

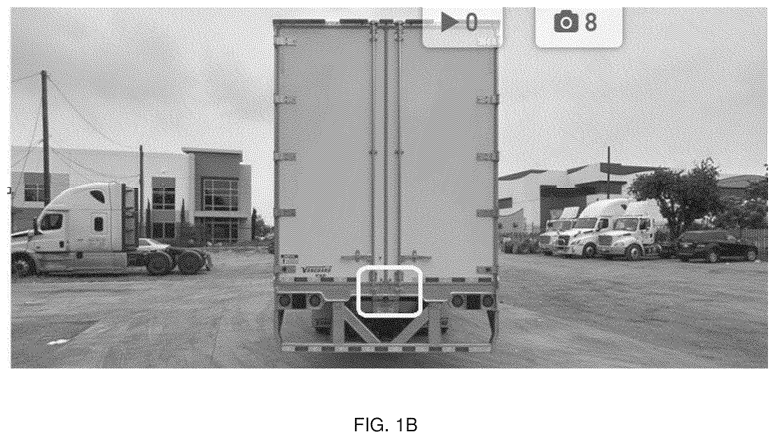

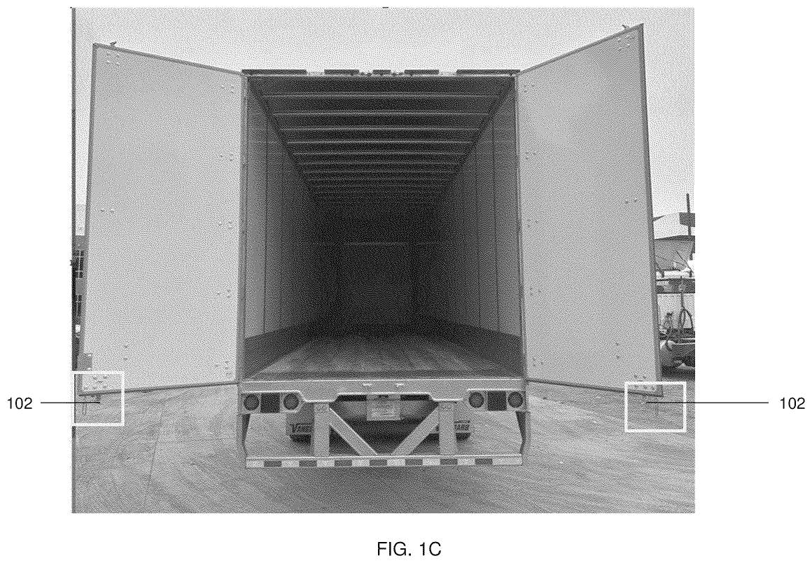

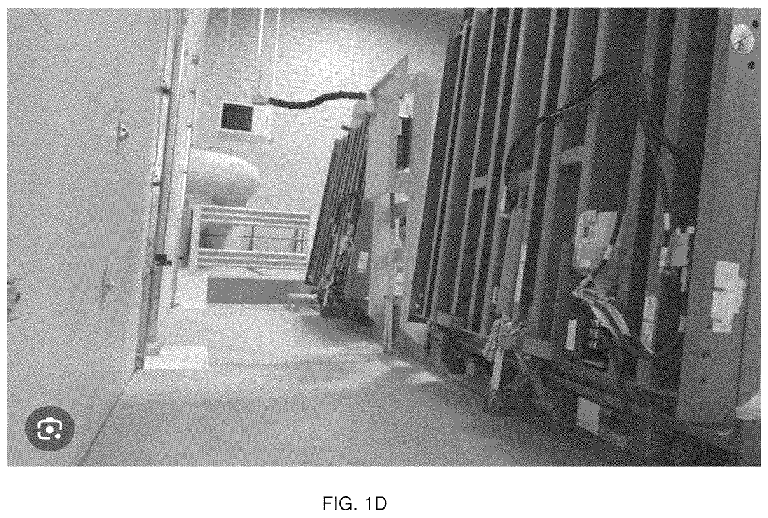

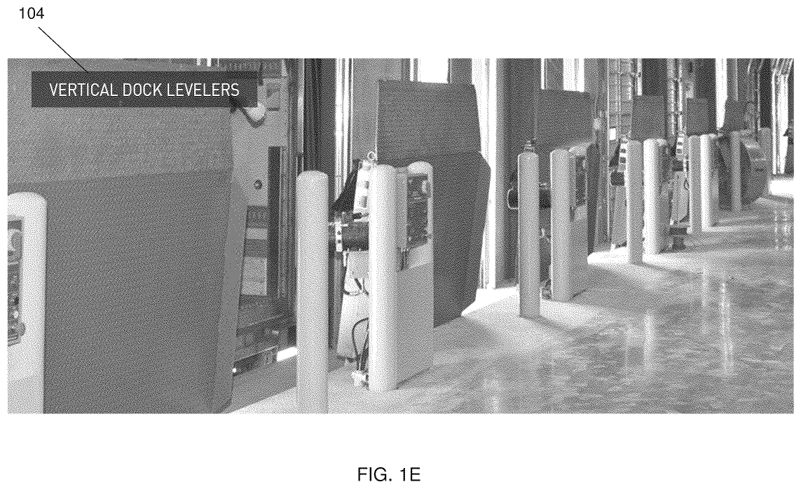

FIG. 1A is an illustration of a side view of an over the road trailer. In the trucking industry the majority of over the road trailers are built using swing doors to enclose the rear of the trailers. In order to open the swing doors on a trailer, they must be opened before the trailer backs into a conventional standard loading dock to avoid the interference from the door latches 102 that sit below the floor of the trailer and door. Typical trailer floors are approximately 48 inches off of grade and standard loading dock designs are 48 inches, not leaving room for the hooks, should they swing at a dock. FIG. 1B is an illustration of a rear view of the trailer of FIG. 1A. FIG. 1C is an illustration of a rear view of the trailer of FIG. 1A, with the rear doors opened.

Even if a building loading dock was built low enough or the trailer was mechanically raised to allow clearance of these latches above the building floor and into the building there are other challenges. The dock door would have to be adequately large to allow the trailer to be offset in one direction or the other to allow the 8 foot, 6 inch wide trailer to open into the building. Standard typical loading dock doors are 96 inches or 108 inches which do not allow for the trailer to be off center by more than 3 inches which is relatively difficult to reliably position. Therefore, to allow for trailer offset tolerance to the building, a 120 inch wide opening is much more effective.

Once the trailer doors are opened into the building another issue arises as the trailer itself will move vertically from the weight of the forklift and/or the load of product inside the trailer, causing the trailer suspension to deflect downwards about 6 inches to 10 inches or more during the loading process. The building would have to be constructed with a step in the floor or the trailer would have to be elevated significantly above the internal floor to allow for this vertical movement of the trailer.

One current approach for this is the use of a “vertical storing dock leveler” along with a concrete step or custom pit to allow for the trailer door movement inside the building, as demonstrated in FIG. 1D. However, to retrofit the vertical storing dock leveler 104 in an existing building, substantial concrete work is required to cut and reinforce the building edge, and a 1,000-2,500 lb. steel weldment must be stored in a vertical position. FIG. 1E is a side view of a plurality of vertical storing dock levelers.

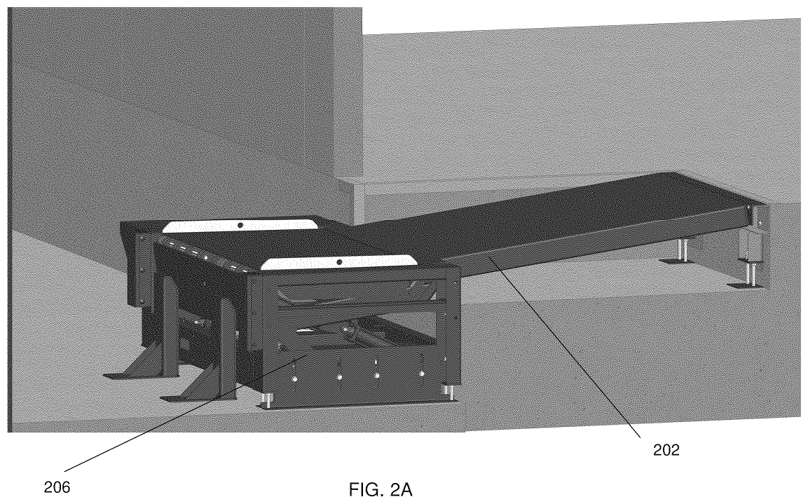

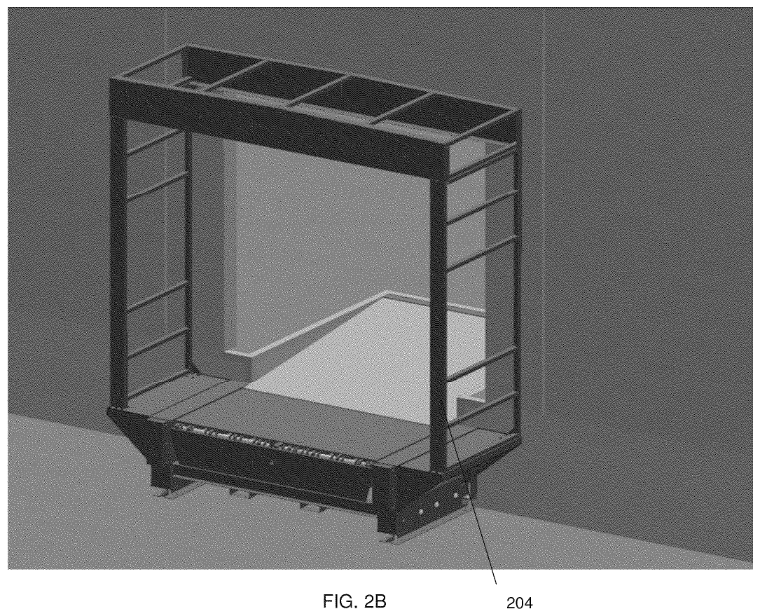

FIG. 2A is an illustration of side view of a split deck ramp 202 for a drive through loading dock, according to various embodiments of the present subject matter. The present application provides a building extension or “dock house” framework 204, along with a hydraulically adjustable ramp with integral dock leveler bridge, to avoid the door opening problem. This approach avoids the existing “pit style” floor mounted dock plate or the need for building a cut out in the building floor only to the size of the ramp. Thus, construction needs to add the split deck leveler are substantially less than the vertical storing dock leveler. In many cases an existing dock pit may be used, thus eliminating associated construction costs altogether.

Externally, a structural steel framework is added to create a building extension, a minimum of 4 feet off the building edge to create adequate space for the trailer doors to swing into the dock house framework. With trailers that have 96 inches to 102 inches in width, this minimum dimension is 48 inches to 60 inches. However, the dock house of the present subject matter can be made to accommodate any building opening. In some examples, the present building extension may be built to first have a 10 foot or wider external dock door, thus creating the space for the trailers to be off center and still open the doors into the dock house.

FIG. 2B is an illustration of perspective view of a split deck ramp for a drive through loading dock including a dock housing, according to various embodiments. In various examples, the dock area of the present subject matter may be built with a lower elevation floor alongside the dock ramps to create a pocket that will create space to allow for the vertical movement of the trailer and doors during the loading process. The dock house having the pockets and split deck leveler includes a number of unique features. For example, the dock house may include a hydraulically adjusted and supported building attached ramp. The ramp may include a hydraulic system 206 configured to support, adjust and hold in place the ramp 202 to create new elevation points for the hinged dock plate. In various examples, the hydraulic ramp may be able to be raised above the building floor and below the building floor. The hydraulic ramp may extend from the inside of the building into the dock house area to support and adjust vertically the rear hinge and deck of a hinged dock plate, in various examples.

According to various embodiments, the present system may include an independent, hinged dock plate including a rear pivot, a middle deck, and a hinged front plate (or lip) that may bridge from the hydraulic ramp into the bed of the trailer. In some examples the hydraulic system 206 may include a float to accommodate the vertical movement of the trailer bed during the loading process. When the hydraulic ramp is lowered to the lowest position, a lip stop or keeper may be used to raise the deck of the dock plate to transform the bridge of the dock plate into a level, approximately horizontal, work platform where an operator may stand to open and close the trailer doors, in various examples. In some examples, when the hydraulic ramp is in this position, the upper portion nearest the building may be used as a walking ramp for the operator to safely walk down the slope of the ramp and onto the level work platform.

In various examples, externally to the building, the dock house may include an enclosure to keep elements off the workers and product being moved to and from the trailer. The dock house of the present subject matter may include an adjustable steel framework that is designed to absorb and transfer trailer impact loads from the trailer into the approach and building wall, in some examples. In various embodiments, the dock house 204 may include a lower floor level than the trailer or the building, to allow vertical motion of the trailer doors without interference.

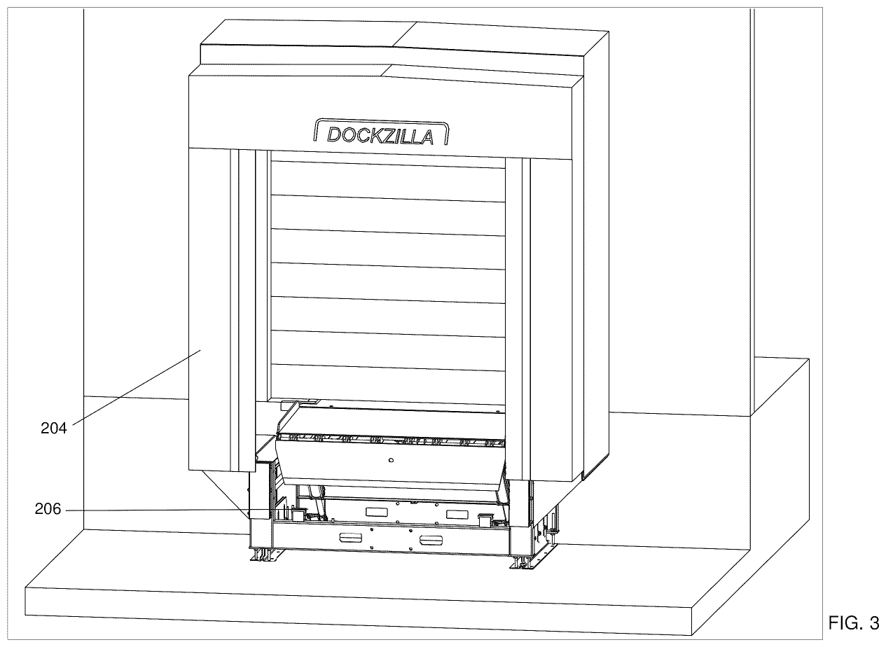

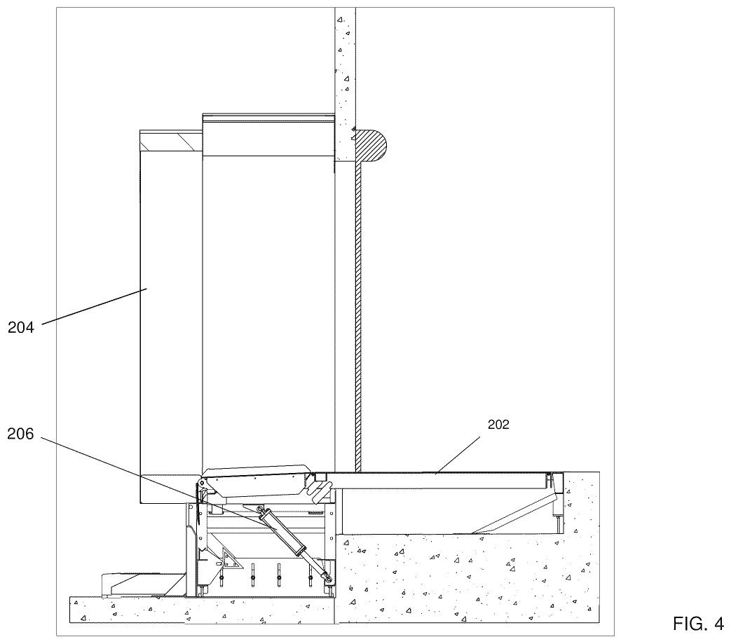

FIG. 3 is an illustration of perspective view from outside a building of a loading dock in the stored position, according to various embodiments. The loading dock includes a split deck ramp 202 including a platform portion 208 configured to be actuated to an approximately horizontal position for safety of a user standing on the platform portion. A base includes top and bottom surfaces, the top surface including an opening to receive the split deck ramp into the opening. A dock housing includes a frame mounted onto the base and configured to be secured to a wall of a building. The dock housing 204 and split deck ramp 202 are configured to provide a lower elevation floor compared to an elevation of a floor of the building, to create a pocket for opening rear vehicle doors 250 and allowing for vertical movement of the back end of the vehicle and the doors. The building doors are shown in the closed position. FIG. 4 is an illustration of a section view of the loading dock of FIG. 3. In various examples, the loading dock (or any of the depicted loading docks) may be a modular loading dock. In other examples, the loading dock may be a fixed or permanent loading dock. The frame may be a modular frame, in various examples. In other examples, the frame may be a fixed or permanent frame.

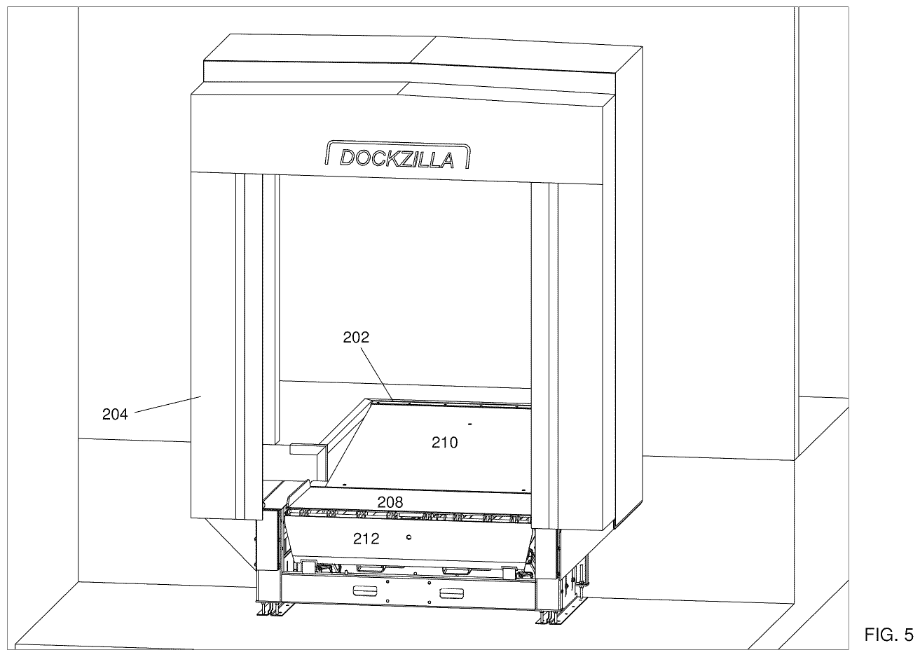

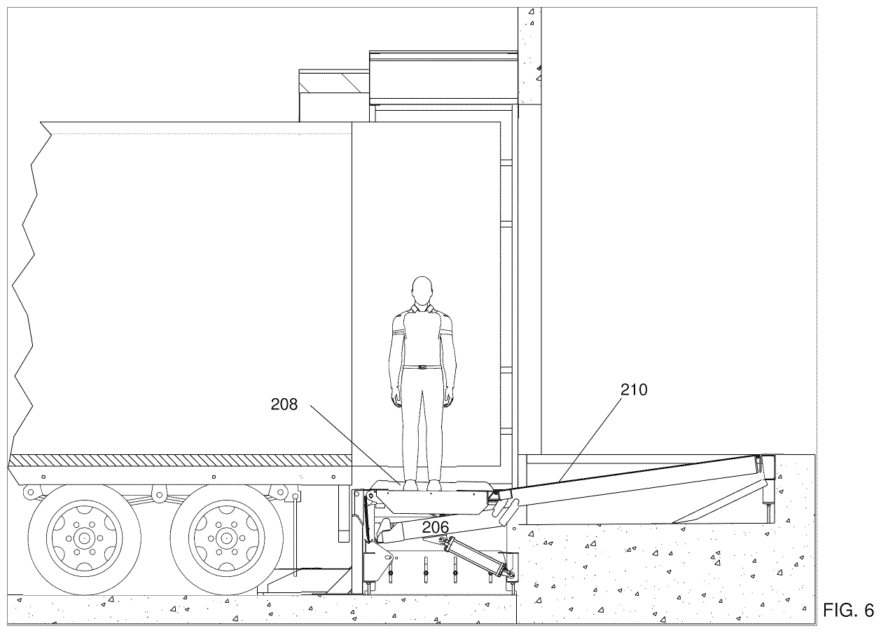

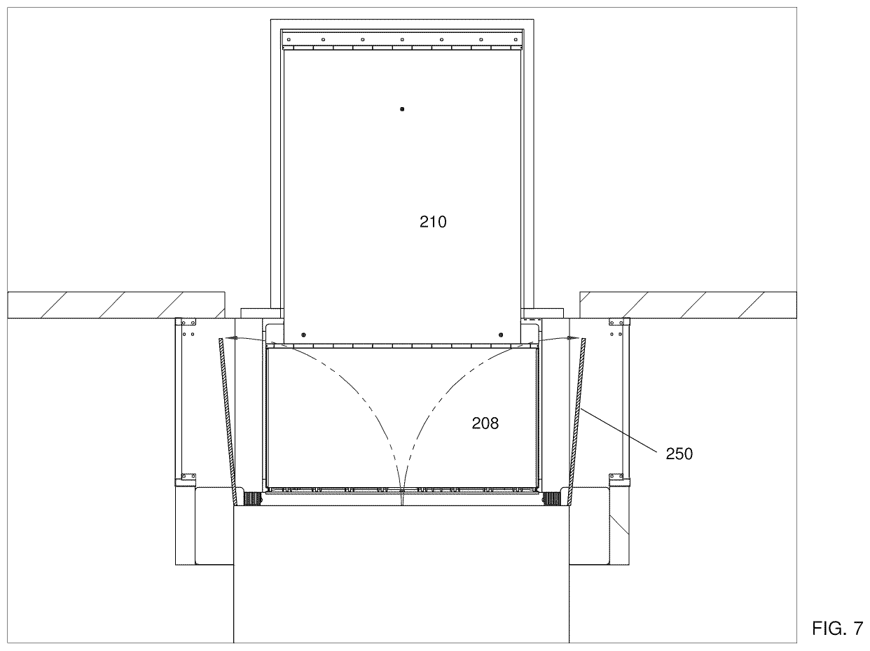

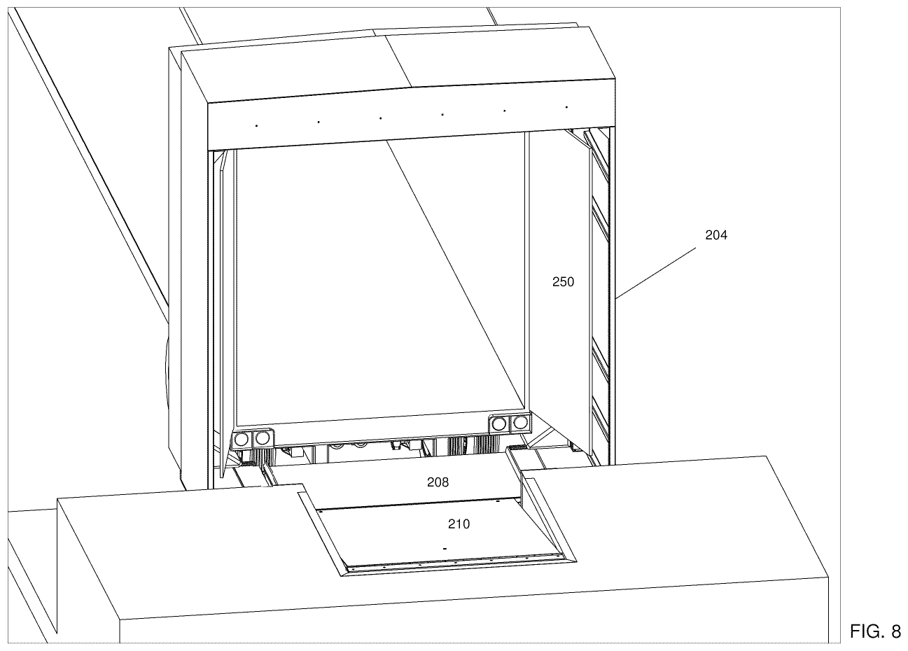

FIG. 5 is an illustration of perspective view from outside a building of the loading dock in the lowered position, according to various embodiments. The building doors are shown in the open position. The upper portion 210 of the ramp 202 includes a secure surface to provide personnel a safe walking path to the lower-level work platform 208 to open the swing doors of a trailer. FIG. 6 is an illustration of a section view of the loading dock of FIG. 5. FIG. 7 is an illustration of a plan view of the loading dock of FIG. 5, further showing swing doors being opened over the level work platform. FIG. 8 is an illustration of perspective view from inside a building of a loading dock in the lowered position, according to various embodiments. In some examples, the loading dock may include a latch or other mechanism to retain the doors in the open position. The door retaining mechanism may be permanently or detachably attached to the loading dock, to a wall, and/or to a frame, in various examples.

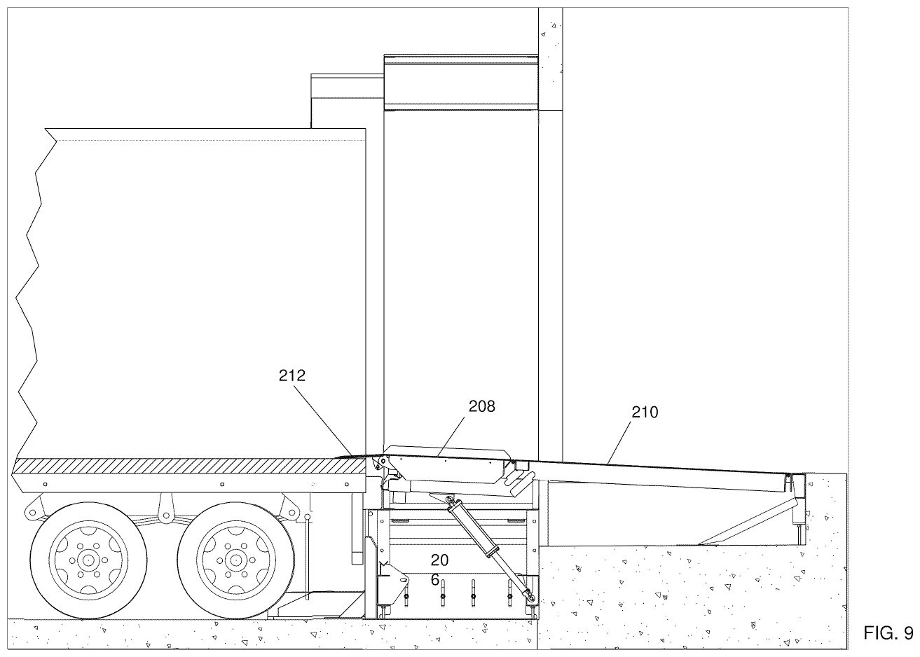

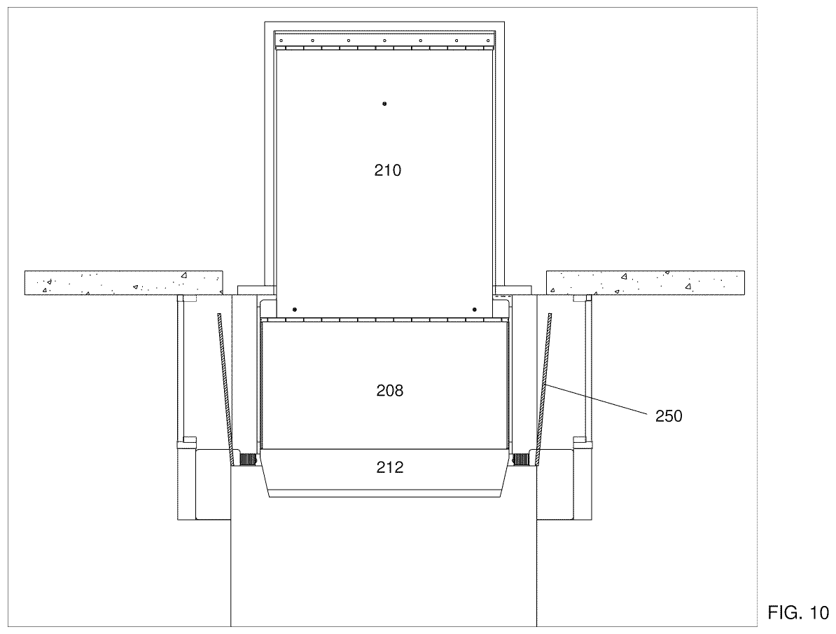

FIG. 9 is an illustration of a section view of the loading dock with a ramp in an inclined position and with a lip 212 of the platform resting on a trailer bed, according to various embodiments. In this embodiment, the loading dock is able to service higher bed height trailers. FIG. 10 is an illustration of a plan view of the loading dock of FIG. 9.

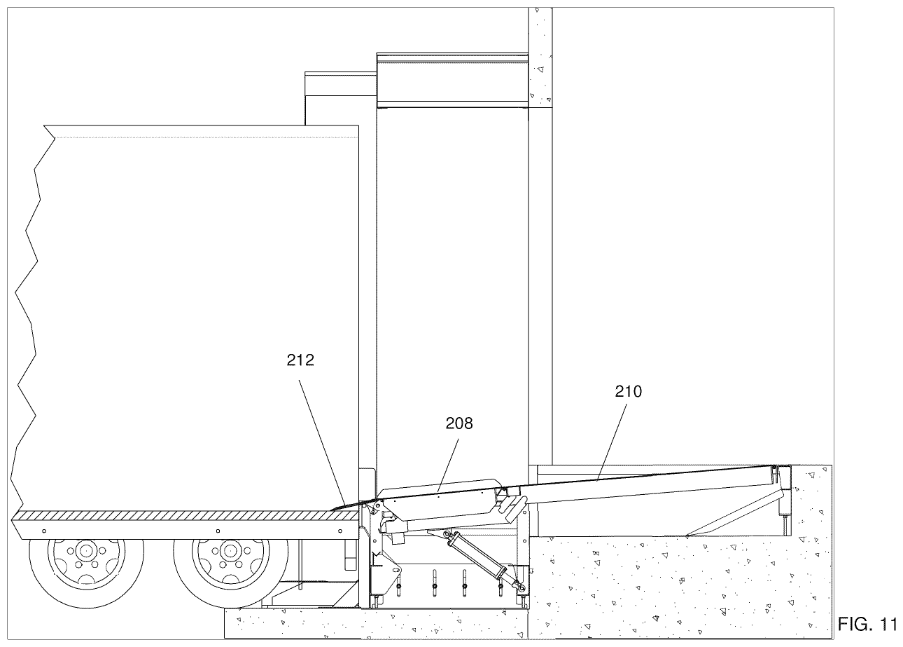

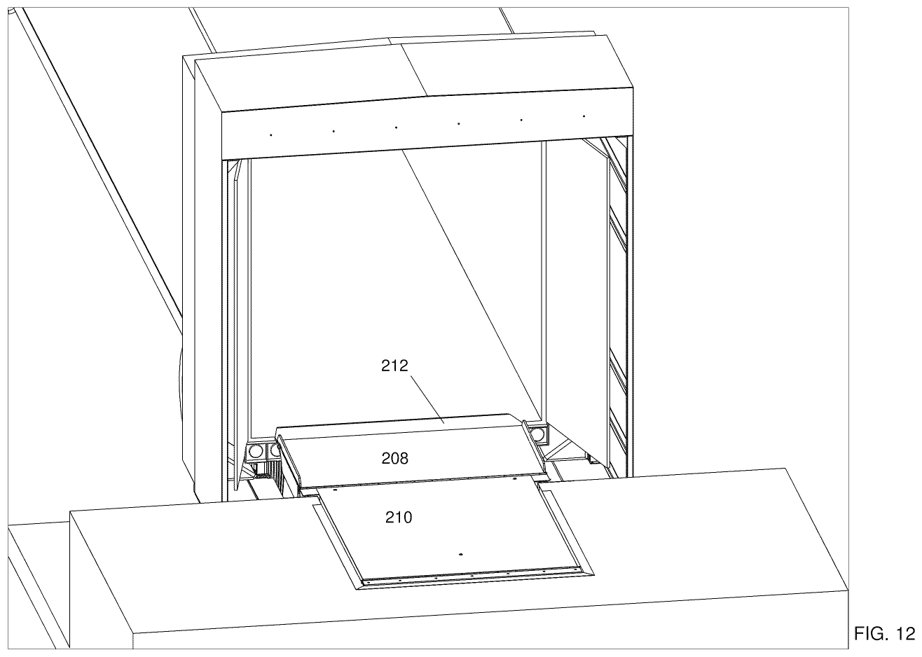

FIG. 11 is an illustration of a section view of the loading dock with a ramp in a declined position and with a lip 212 of the platform resting on a trailer bed, according to various embodiments. In this embodiment, the loading dock is able to service lower bed height trailers. FIG. 12 is an illustration of perspective view from inside a building of a loading dock in the level position and with a lip 212 of the platform resting on a trailer bed, according to various embodiments.

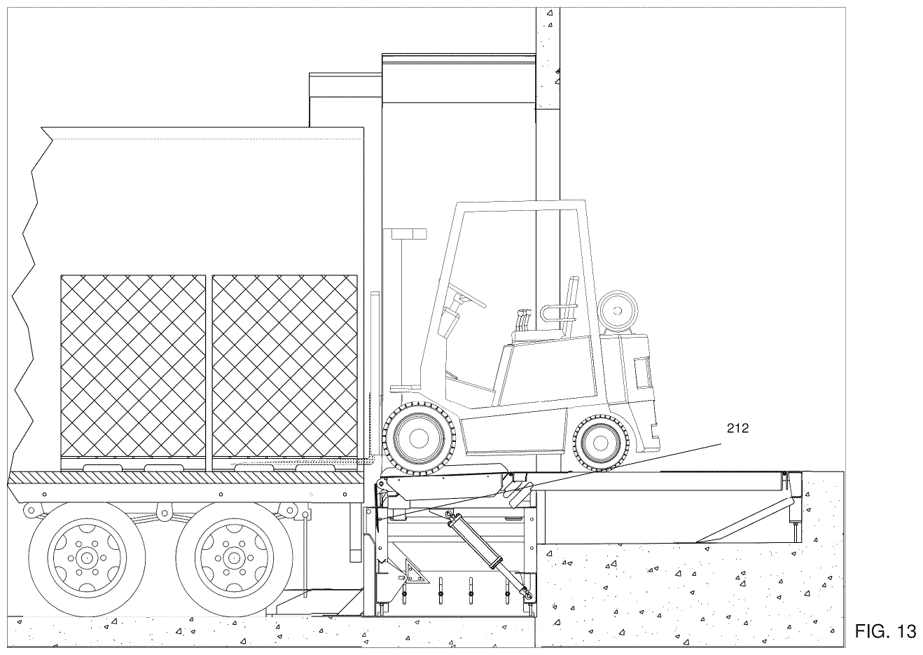

FIG. 13 is an illustration of a section view of the loading dock with a ramp in an approximately level position and with a lip 212 of the platform disengaged such that the end of the platform abuts the end of a trailer bed, according to various embodiments. In this embodiment, loads of cargo that are up to the end of the trailer, and which would interfere with the lip engaging the trailer, are able to be unloaded in a process known as end loading or end unloading.

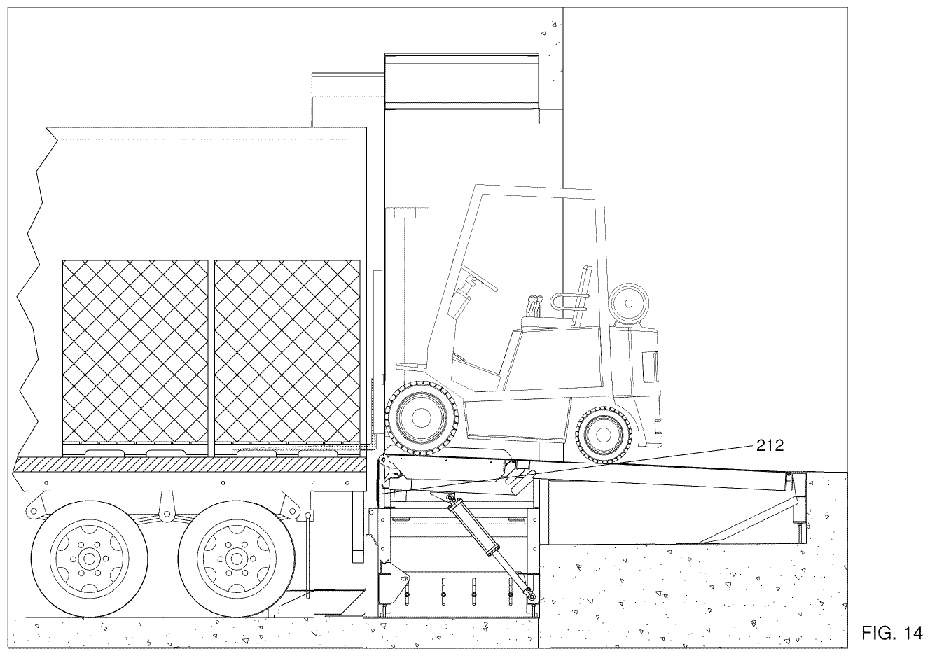

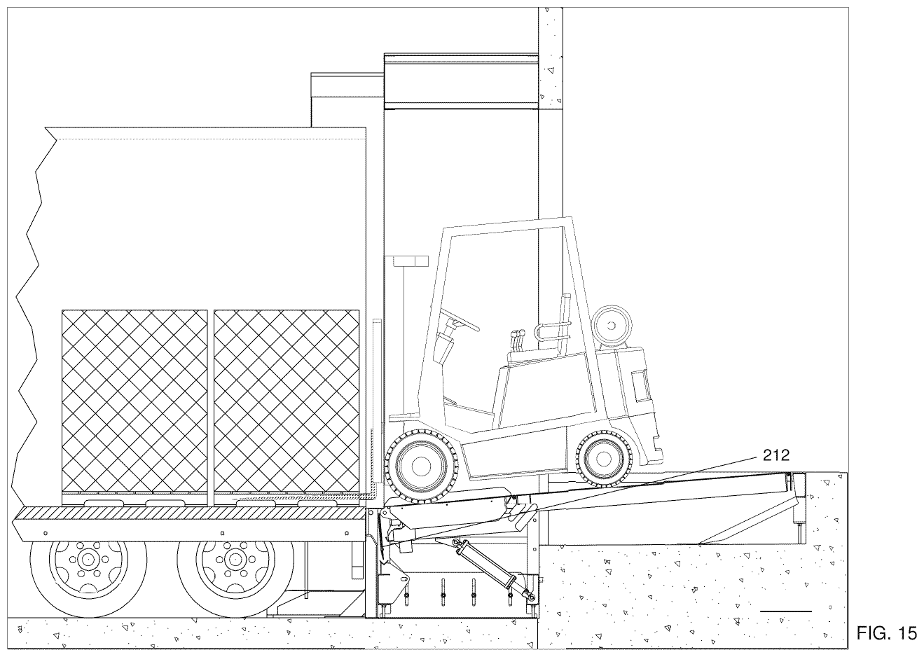

FIG. 14 is an illustration of a section view of the loading dock of FIG. 13 with the ramp in an inclined position and with a lip 212 of the platform disengaged such that the end of the platform abuts the end of a trailer bed, according to various embodiments. FIG. 15 is an illustration of a section view of the loading dock of FIG. 13 with the ramp in a declined position and with a lip 212 of the platform disengaged such that the end of the platform abuts the end of a trailer bed, according to various embodiments. These views illustrate that the ramp is fully adjustable and hydraulically supportable for the weight of a fork lift in multiple height positions to accommodate various end loading or unloading trailer heights. In various examples, the split deck leveler may be used with or without a dock housing.

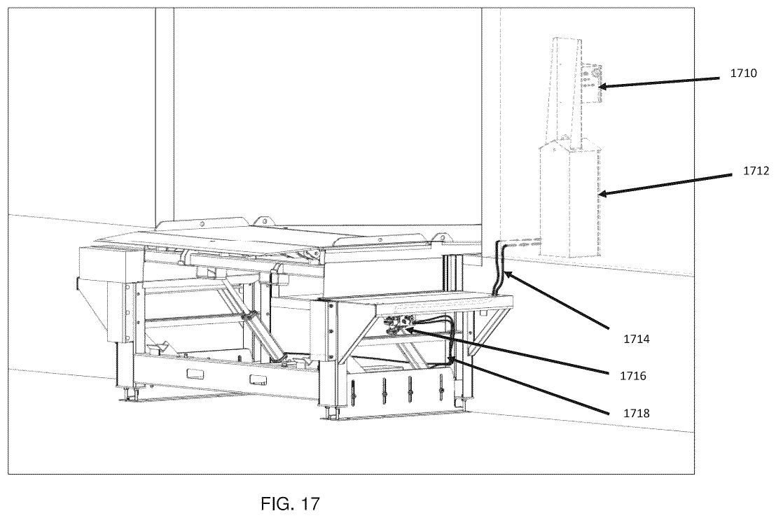

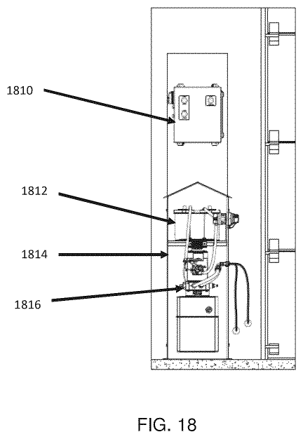

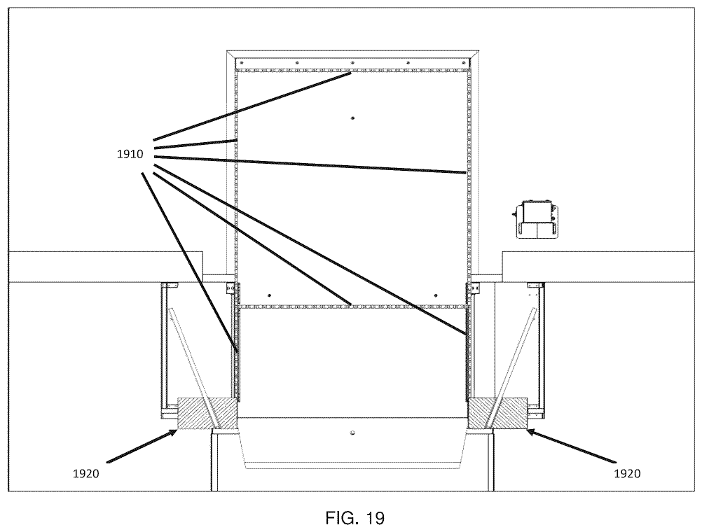

FIGS. 17-21 illustrate the hydraulic and environmental protection systems integrated into the loading dock, in various embodiments. FIGS. 17-18 show the hydraulic system components, including the control box, hydraulic power unit (HPU), and associated lines, which enable precise control and adjustment of the split deck ramp, enhancing operational safety and efficiency, in various examples. FIGS. 19-21 focus on environmental protection and impact absorption features, such as weather seals and foam blocks, which safeguard the dock area from external elements and pests, according to various embodiments. These features collectively ensure a controlled environment for loading and unloading operations, protecting both personnel and goods from adverse conditions and potential damage.

FIG. 17 illustrates a detailed view of the hydraulic system components associated with the split deck ramp for a drive-through loading dock. A control box 1710 is provided, which is responsible for managing the hydraulic operations in one example. Adjacent to the control box is the hydraulic power unit (HPU) enclosure 1712, housing the hydraulic power unit that supplies the pressure used to actuate the ramp. The upper hydraulic lines 1714 are depicted as conduits for hydraulic fluid from the HPU to the split deck valve block, facilitating the movement of the ramp. The split deck manifold 1716 serves as a distribution point for the hydraulic fluid, ensuring efficient operation of the system. Additionally, the lower hydraulic lines 1718 are shown, which distribute hydraulic fluid from the split deck valve block to hydraulic cylinders that control the ramp, platform and lip, thereby maintaining the functionality of the ramp's adjustable features. This configuration allows for precise control and adjustment of the ramp's position, enhancing the safety and efficiency of the loading dock operations.

FIG. 18 provides an illustration of the hydraulic system components for the operation of the split deck ramp in a drive-through loading dock. The figure highlights the control box 1810 (such as control box 1710 in FIG. 17), which is essential for overseeing the hydraulic functions and ensuring smooth operation. Below the control box, the battery 1812 is depicted, providing the necessary power to the system. The HPU enclosure 1814 (such as HPU enclosure 1712 in FIG. 17) is shown housing the hydraulic power unit (HPU) 1816, which generates the hydraulic pressure required to actuate the ramp, platform and lip. This setup ensures that the ramp can be precisely controlled and adjusted, contributing to the overall safety and efficiency of the loading dock system.

FIG. 19 illustrates a plan view of the loading dock, focusing on the components that provide environmental protection. The weather seal 1910 is prominently featured, designed to prevent external elements such as rain, external cold or hot air, dust, debris and pests from entering the dock area, thereby ensuring a clean and safe environment for loading and unloading operations. Additionally, foam blocks 1920 provide a seal against the door and trailer to prevent external elements from intrusion and to regulate temperature. This configuration enhances the dock's ability to maintain a controlled environment, protecting both the personnel and the goods being handled from adverse weather conditions and potential damage.

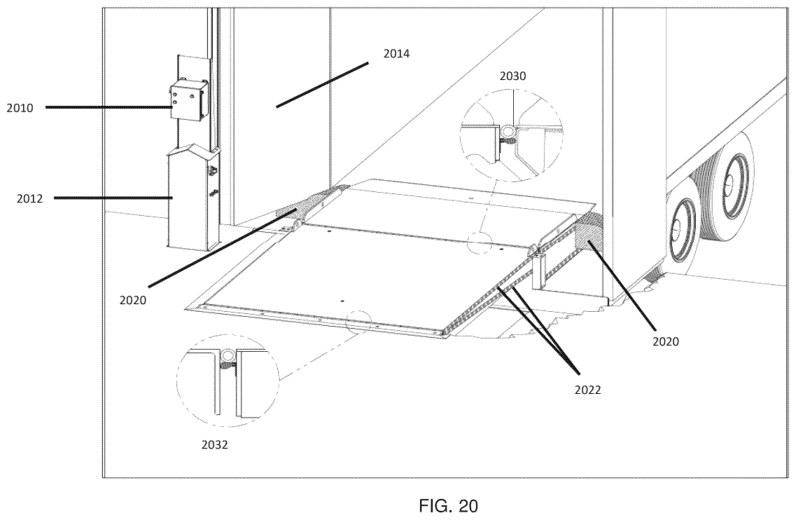

FIG. 20 presents a perspective view from inside a building of the loading dock, highlighting components that contribute to its functionality and protection. The control box 2010 (such as control box 1710 in FIG. 17) is shown, which is used for managing the operations of the dock. Adjacent to the control box is the HPU enclosure 2012, which houses the hydraulic power unit used for actuating the ramp. The trailer door 2014 is depicted, illustrating its position relative to the dock. The foam block 2020 and weather seal 2022 are also shown, providing cushioning and protection against environmental elements, respectively. The foam block 2020 seals against the door and trailer, in some examples. Additionally, the figure includes first detail view 2030 and second detail view 2032, offering closer inspection of specific areas of the dock, further emphasizing the design considerations for environmental sealing when unloading a trailer during use of the dock. In first detail view 2030, the weather seal 2022 is provided between the leveler and the deck. In second detail view 2032, the weather seal 2022 is applied across the back deck. The weather seal 2022 may press on sides of the concrete pit, in some examples. This configuration ensures the dock's operational efficiency and safety during loading and unloading processes.

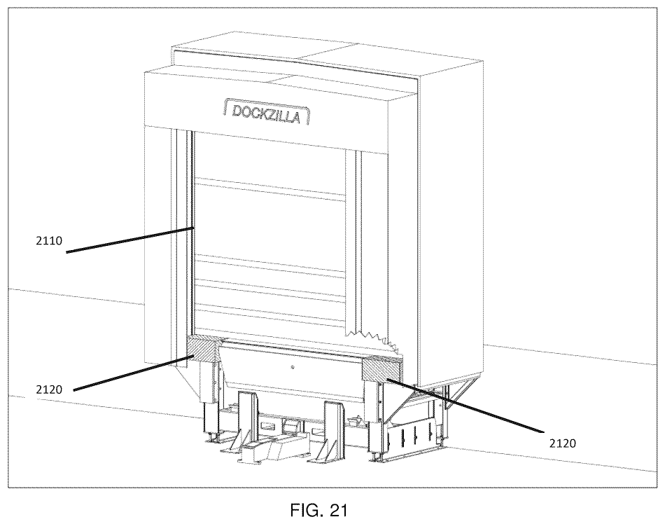

FIG. 21 illustrates a perspective view of the loading dock, emphasizing the components designed for environmental protection and pest control. The weather seal 2110 is prominently featured, serving to shield the dock area from external elements such as rain, external hot or cold air, dust, and debris, thereby maintaining a clean and safe environment for loading and unloading activities. This configuration enhances the dock's ability to protect both personnel and goods from adverse weather conditions and potential damage, ensuring efficient and safe operations.

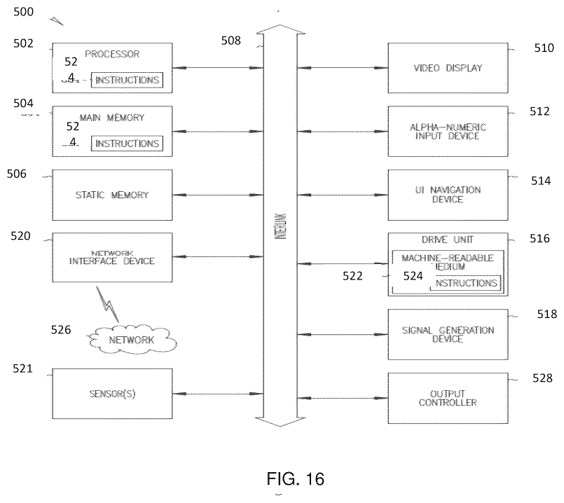

FIG. 16 illustrates a block diagram of an example machine 500 upon which any one or more of the techniques (e.g., methodologies) discussed herein may perform. In alternative embodiments, the machine 500 may operate as a standalone device or may be connected (e.g., networked) to other machines. In a networked deployment, the machine 500 may operate in the capacity of a server machine, a client machine, or both in server-client network environments. In an example, the machine 500 may act as a peer machine in peer-to-peer (P2P) (or other distributed) network environment. The machine 500 may be configured to perform the methods described herein. The machine 500 may be in the form of a personal computer (PC), a tablet PC, a set-top box (STB), a personal digital assistant (PDA), a mobile telephone, a smart phone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein, such as cloud computing, software as a service (SaaS), other computer cluster configurations.

Examples, as described herein, may include, or may operate on, logic or a number of components, modules, or mechanisms. Modules are tangible entities (e.g., hardware) capable of performing specified operations and may be configured or arranged in a certain manner. In an example, circuits may be arranged (e.g., internally or with respect to external entities such as other circuits) in a specified manner as a module. In an example, the whole or part of one or more computer systems (e.g., a standalone, client or server computer system) or one or more hardware processors may be configured by firmware or software (e.g., instructions, an application portion, or an application) as a module that operates to perform specified operations. In an example, the software may reside on a machine readable medium. In an example, the software, when executed by the underlying hardware of the module, causes the hardware to perform the specified operations.

Accordingly, the term “module” is understood to encompass a tangible entity, be that an entity that is physically constructed, specifically configured (e.g., hardwired), or temporarily (e.g., transitorily) configured (e.g., programmed) to operate in a specified manner or to perform part or all of any operation described herein. Considering examples in which modules are temporarily configured, each of the modules need not be instantiated at any one moment in time. For example, where the modules comprise a general-purpose hardware processor configured using software, the general-purpose hardware processor may be configured as respective different modules at different times. Software may accordingly configure a hardware processor, for example, to constitute a particular module at one instance of time and to constitute a different module at a different instance of time.

Machine (e.g., computer system) 500 may include a hardware processor 502 (e.g., a central processing unit (CPU), a graphics processing unit (GPU), a hardware processor core, or any combination thereof), a controller, a microcontroller, a microprocessor, a main memory 504 and a static memory 506, some or all of which may communicate with each other via an interlink (e.g., bus) 508. The machine 500 may further include a display unit 510, an alphanumeric input device 512 (e.g., a keyboard), and a user interface (UI) navigation device 514 (e.g., a mouse). In an example, the display unit 510, input device 512 and UI navigation device 514 may be a touch screen display. The machine 500 may additionally include a storage device (e.g., drive unit) 516, a signal generation device 518 (e.g., a speaker), a network interface device 520, and one or more sensors 521, such as a global positioning system (GPS) sensor, compass, accelerometer, or other sensor. The machine 500 may include an output controller 528, such as a serial (e.g., universal serial bus (USB), parallel, or other wired or wireless (e.g., infrared (IR), near field communication (NFC), etc.) connection to communicate or control one or more peripheral devices (e.g., a printer, card reader, etc.).

The storage device 516 may include a machine readable medium 522 on which is stored one or more sets of data structures or instructions 524 (e.g., software) embodying or utilized by any one or more of the techniques or functions described herein. The instructions 524 may also reside, completely or at least partially, within the main memory 504, within static memory 506, or within the hardware processor 502 during execution thereof by the machine 500. In an example, one or any combination of the hardware processor 502, the main memory 504, the static memory 506, or the storage device 516 may constitute machine readable media.

While the machine readable medium 522 is illustrated as a single medium, the term “machine readable medium” may include a single medium or multiple media (e.g., a centralized or distributed database, and/or associated caches and servers) configured to store the one or more instructions 524.

The term “machine readable medium” may include any medium that is capable of storing, encoding, or carrying instructions for execution by the machine 500 and that cause the machine 500 to perform any one or more of the techniques of the present disclosure, or that is capable of storing, encoding or carrying data structures used by or associated with such instructions. Non-limiting machine-readable medium examples may include solid-state memories, and optical and magnetic media. Specific examples of machine-readable media may include: non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; Random Access Memory (RAM); Solid State Drives (SSD); and CD-ROM and DVD-ROM disks. In some examples, machine readable media may include non-transitory machine-readable media. In some examples, machine readable media may include machine readable media that is not a transitory propagating signal.

The instructions 524 may further be transmitted or received over a communications network 526 using a transmission medium via the network interface device 520. The Machine 500 may communicate with one or more other machines utilizing any one of a number of transfer protocols (e.g., frame relay, internet protocol (IP), transmission control protocol (TCP), user datagram protocol (UDP), hypertext transfer protocol (HTTP), etc.). Example communication networks may include wired and wireless communications, such as Ethernet, Bluetooth, Bluetooth Low Energy, other Personal Area Networks (PANs), LoRa, NFC, Wi-Fi, WiMAX, 3G, 4G, LTE, 5G, the unlicensed 915 MHz Industrial, Scientific, and Medical (ISM) frequency band, ZigBee, among others. Some standards may support mesh networks. The networks include, but are not limited to, a local area network (LAN), a low-power wide-area network (LPWAN), a wide area network (WAN), a packet data network (e.g., the Internet), mobile telephone networks (e.g., cellular networks), Plain Old Telephone (POTS) networks, and wireless data networks, e.g., Institute of Electrical and Electronics Engineers (IEEE) 802.11 family of standards known as Wi-Fi®, IEEE 802.16 family of standards known as WiMax®, NFC, IEEE 802.15.4 family of standards, a Long Term Evolution (LTE) family of standards, a Universal Mobile Telecommunications System (UMTS) family of standards, peer-to-peer (P2P) networks, among others. The NFC circuitry may be embodied as relatively short-range, high frequency wireless communication circuitry and may implement standards such as ECMA-340/ISO/IEC 18092 and/or ECMA-352/ISO/IEC 21481 to communicate with other devices. In an example, the network interface device 520 may include one or more physical jacks (e.g., Ethernet, coaxial, or phone jacks) or one or more antennas to connect to the communications network 526. In an example, the network interface device 520 may include a plurality of antennas to wirelessly communicate using at least one of single-input multiple-output (SIMO), multiple-input multiple-output (MIMO), or multiple-input single-output (MISO) techniques. In some examples, the network interface device 520 may wirelessly communicate using Multiple User MIMO techniques.

### Other Notes and Examples

Example 1 is a loading dock, including a split deck ramp including a lower end and an upper end, the upper end abutting a preexisting structure and the lower end including a lower edge, the split deck ramp including a platform portion adjacent the lower edge configured to be actuated to an approximately horizontal position for safety of a user standing on the platform portion, a base including top and bottom surfaces, the top surface including an opening to receive the split deck ramp into the opening, and a dock housing including a frame mounted onto the base in sections, the sections including a frame-front wall, opposed frame-sidewalls and a frame-top wall, the frame-front wall including a vehicle-receiving opening to receive a back end of a vehicle, the frame-sidewalls configured to be secured to a wall of a building, the dock housing and the split deck ramp configured to provide a lower elevation floor compared to an elevation of a floor of the building, to create a pocket for opening rear vehicle doors and allowing for vertical movement of the back end of the vehicle and the doors during a loading or unloading process.

In Example 2, the subject matter of Example 1 includes, wherein the platform includes, at a distal edge, a lip, the lip being able to be activated between an extended position and a retracted position.

In Example 3, the subject matter of Example 1 includes, wherein the split deck ramp is configured to be hydraulically actuated.

In Example 4, the subject matter of Example 1 includes, wherein the split deck ramp includes a hinge between the upper end and the platform portion.

In Example 5, the subject matter of Example 1 includes, wherein the platform portion is approximately four feet in length.

In Example 6, the subject matter of Example 1 includes, wherein the split deck ramp is adjustable and allows an operator to adjust a height position of the split deck ramp with a pushbutton control, the split deck ramp configured to hold the height position once it has been adjusted.

In Example 7, the subject matter of Example 6 includes, wherein the split deck ramp is configured to support at least a weight of a fork lift and fork lift payload once it has been adjusted.

In Example 8, the subject matter of Example 6 includes, wherein the split deck ramp is configured to be adjusted to an elevation above or below the floor of the building.

In Example 9, the subject matter of Example 1 includes, wherein the upper end of the split deck ramp is configured to provide a walk ramp for the user to access the platform portion.

In Example 10, the subject matter of Example 1 includes, wherein the dock housing is configured to create an enclosure to provide at least some shelter from external elements for the user.

In Example 11, the subject matter of Example 1 includes, wherein the dock housing is configured to substantially absorb impacts from the back end of the vehicle.

In Example 12, the subject matter of Example 1 includes, wherein the frame-sidewalls are configured to be bolted to the wall of the building.

In Example 13, the subject matter of Example 1 includes, wherein the base includes a securement mechanism for connection and securement of the frame-sidewalls to the base.

In Example 14, the subject matter of Example 1 further includes a weather seal configured to prevent external elements from entering an interior of the building.

In Example 15, the subject matter of Example 1 includes, wherein at least one of the split deck ramp, the base, and the dock housing are removable and able to be transported to different locations.

In Example 16, the subject matter of Example 1 includes, wherein the base includes a steel base.

In Example 17, the subject matter of Example 1 further includes a foam block positioned to limit ingress of external elements and provide insulation.

In Example 18, the subject matter of Example 1 includes, wherein the loading dock includes a modular loading dock.

In Example 19, the subject matter of Example 1 includes, wherein the frame includes a modular frame.

Example 20 is a method of making a loading dock, the method including providing a split deck ramp including a lower end and an upper end, the upper end abutting a preexisting structure and the lower end including a lower edge, the split deck ramp including a platform portion adjacent the lower edge configured to be actuated to an approximately horizontal position for safety of a user standing on the platform portion, providing a base including top and bottom surfaces, the top surface including an opening to receive the split deck ramp into the opening, and providing a dock housing including a frame mounted onto the base in sections, the sections including a frame-front wall, opposed frame-sidewalls and a frame-top wall, the frame-front wall including a vehicle-receiving opening to receive a back end of a vehicle, the frame-sidewalls configured to be secured to a wall of a building, the dock housing and the split deck ramp configured to provide a lower elevation floor compared to an elevation of a floor of the building, to create a pocket for opening rear vehicle doors and allowing for vertical movement of the back end of the vehicle and the doors during a loading or unloading process.

In Example 21, the subject matter of Example 20 includes, wherein the platform includes, at a distal edge, a lip, the lip being able to be activated between an extended position and a retracted position.

In Example 22, the subject matter of Example 20 includes, wherein the split deck ramp is adjustable and allows an operator to adjust a height position of the split deck ramp with a pushbutton control, the split deck ramp configured to hold the height position once it has been adjusted.

In Example 23, the subject matter of Example 22 includes, wherein the split deck ramp is configured to support at least a weight of a fork lift and fork lift payload once it has been adjusted.

In Example 24, the subject matter of Example 22 includes, wherein the split deck ramp is configured to be adjusted to an elevation above or below the floor of the building.

In Example 25, the subject matter of Example 20 includes, wherein the upper end of the split deck ramp is configured to provide a walk ramp for the user to access the platform portion.

In Example 26, the subject matter of Example 20 further includes installing a weather seal to prevent external elements from entering an interior of the building.

In Example 27, the subject matter of Example 20 includes, wherein the dock housing is configured to substantially absorb impacts from the back end of the vehicle.

In Example 28, the subject matter of Example 20 further includes installing a foam block to prevent external elements and provide insulation.

In Example 29, the subject matter of Example 20 includes, wherein the loading dock includes a modular loading dock.

In Example 30, the subject matter of Example 20 includes, wherein the frame includes a modular frame.

Example 31 is a split deck loading apparatus including a ramp including a lower end and an upper end, the upper end abutting a preexisting structure and the lower end including a lower edge, and a platform portion connected to and adjacent the lower edge configured to be actuated to an approximately horizontal position for safety of a user standing on the platform portion, wherein the platform portion is configured to provide a lower elevation floor compared to an elevation of a floor of the preexisting structure, to provide clearance for opening rear vehicle doors and allowing for vertical movement of a back end of a vehicle and the doors during a loading or unloading process.

In Example 32, the subject matter of Example 31 further includes a lip connected to an end of the platform portion opposite the ramp, the lip being able to be activated between an extended position and a retracted position.

Example 33 is an apparatus comprising means to implement of any of Examples 1-32.

Example 34 is a system to implement of any of Examples 1-32.

Example 35 is a method to implement of any of Examples 1-32.

The foregoing examples are not intended to be an exhaustive or exclusive list of examples and variations of the present subject matter. The above description is intended to be illustrative, and not restrictive. Those of skill in the art will appreciate additional variations of the embodiments that can be used within the scope of the teachings set forth herein. The scope of the invention should be determined with reference to the appended claims, along with the full scope of equivalents to which such claims are entitled.

What is claimed is:

1. A loading dock, comprising:
a split deck ramp including a lower end and an upper end, the upper end abutting a preexisting structure and the lower end including a lower edge, the split deck ramp including a platform portion adjacent the lower edge configured to be actuated to an approximately horizontal position for safety of a user standing on the platform portion;
a base including top and bottom surfaces, the top surface including an opening to receive the split deck ramp into the opening; and
a dock housing including a frame mounted onto the base in sections, the sections including a frame-front wall, opposed frame-sidewalls and a frame-top wall, the frame-front wall including a vehicle-receiving opening to receive a back end of a vehicle, the frame-sidewalls configured to be secured to a wall of a building, the dock housing and the split deck ramp configured to provide a lower elevation floor compared to an elevation of a floor of the building, to create a pocket for opening rear vehicle doors and allowing for vertical movement of the back end of the vehicle and the doors during a loading or unloading process.

2. The loading dock of claim 1, wherein the platform includes, at a distal edge, a lip, the lip being able to be activated between an extended position and a retracted position.

3. The loading dock of claim 1, wherein the split deck ramp is configured to be hydraulically actuated.

4. The loading dock of claim 1, wherein the split deck ramp includes a hinge between the upper end and the platform portion.

5. The loading dock of claim 1, wherein the platform portion is approximately four feet in length.

6. The loading dock of claim 1, wherein the split deck ramp is adjustable and allows an operator to adjust a height position of the split deck ramp with a pushbutton control, the split deck ramp configured to hold the height position once it has been adjusted.

7. The loading dock of claim 6, wherein the split deck ramp is configured to support at least a weight of a fork lift and fork lift payload once it has been adjusted.

8. The loading dock of claim 6, wherein the split deck ramp is configured to be adjusted to an elevation above or below the floor of the building.

9. The loading dock of claim 1, wherein the upper end of the split deck ramp is configured to provide a walk ramp for the user to access the platform portion.

10. The loading dock of claim 1, wherein the dock housing is configured to create an enclosure to provide at least some shelter from external elements for the user.

11. The loading dock of claim 1, wherein the dock housing is configured to substantially absorb impacts from the back end of the vehicle.

12. The loading dock of claim 1, wherein the frame-sidewalls are configured to be bolted to the wall of the building.

13. The loading dock of claim 1, further comprising a weather seal configured to prevent external elements from entering an interior of the building.

14. The loading dock of claim 1, wherein at least one of the split deck ramp, the base, and the dock housing are removable and able to be transported to different locations.

15. The loading dock of claim 1, further comprising a foam block positioned to limit ingress of external elements and provide insulation.

16. The loading dock of claim 1, wherein the loading dock includes a modular loading dock.

17. The loading dock of claim 1, wherein the frame includes a modular frame.

18. A method of making a loading dock, the method comprising:
providing a split deck ramp including a lower end and an upper end, the upper end abutting a preexisting structure and the lower end including a lower edge, the split deck ramp including a platform portion adjacent the lower edge configured to be actuated to an approximately horizontal position for safety of a user standing on the platform portion;
providing a base including top and bottom surfaces, the top surface including an opening to receive the split deck ramp into the opening; and
providing a dock housing including a frame mounted onto the base in sections, the sections including a frame-front wall, opposed frame-sidewalls and a frame-top wall, the frame-front wall including a vehicle-receiving opening to receive a back end of a vehicle, the frame-sidewalls configured to be secured to a wall of a building, the dock housing and the split deck ramp configured to provide a lower elevation floor compared to an elevation of a floor of the building, to create a pocket for opening rear vehicle doors and allowing for vertical movement of the back end of the vehicle and the doors during a loading or unloading process.

19. The method of claim 18, wherein the platform includes, at a distal edge, a lip, the lip being able to be activated between an extended position and a retracted position.

20. The method of claim 18, wherein the split deck ramp is adjustable and allows an operator to adjust a height position of the split deck ramp with a pushbutton control, the split deck ramp configured to hold the height position once it has been adjusted.

21. The method of claim 20, wherein the split deck ramp is configured to support at least a weight of a fork lift and fork lift payload once it has been adjusted.

22. The method of claim 20, wherein the split deck ramp is configured to be adjusted to an elevation above or below the floor of the building.

23. The method of claim 18, further comprising installing a weather seal to prevent external elements from entering an interior of the building.

24. The method of claim 18, further comprising installing a foam block to limit ingress of external elements and provide insulation.

25. The method of claim 18, wherein the loading dock includes a modular loading dock.

26. The method of claim 18, wherein the frame includes a modular frame.

27. A split deck loading apparatus comprising:
a ramp including a lower end and an upper end, the upper end abutting a preexisting structure and the lower end including a lower edge; and
a platform portion connected to and adjacent the lower edge configured to be actuated to an approximately horizontal position for safety of a user standing on the platform portion;
wherein the platform portion is configured to provide a lower elevation floor compared to an elevation of a floor of the preexisting structure, to provide clearance for opening rear vehicle doors and allowing for vertical movement of a back end of a vehicle and the doors during a loading or unloading process.

28. The apparatus of claim 27, further comprising a lip connected to an end of the platform portion opposite the ramp, the lip being able to be activated between an extended position and a retracted position.
